(19) United States
(12) Patent Application Publication
(10) Pub. No.: US 2025/0360706 A1
(43) Pub. Date: Nov. 27, 2025

(54) LIQUID DISCHARGE APPARATUS, LIQUID DISCHARGE METHOD, AND STORAGE MEDIUM

(71) Applicant: Kenji Kamei, Kanagawa (JP)

(72) Inventor: Kenji Kamei, Kanagawa (JP)

(73) Assignee: Ricoh Company, Ltd., Tokyo (JP)

(21) Appl. No.: 19/293,091

(22) Filed: Aug. 7, 2025

Related U.S. Application Data
(63) Continuation of application No. 17/992,389, filed on Nov. 22, 2022.

(30) Foreign Application Priority Data
Dec. 27, 2021 (JP) 2021-213156

(51) Int. Cl. B41J 2/045

(52) U.S. Cl. CPC B41J 2/04541; B41J 2/04556; B41J 2/04581

(57) ABSTRACT

A liquid discharge apparatus includes a head and circuitry. The head discharges liquid to apply the liquid to an application surface. The circuitry controls discharge of the liquid from the head based on a vertical height of an application position at which the liquid is applied on the application surface.

### CROSS-REFERENCE TO RELATED APPLICATIONS

This patent application is a Continuation application U.S. patent application Ser. No. 17/992,389, which is based on and claims priority pursuant to 35 U.S.C. § 119 (a) to Japanese Patent Application No. 2021-213156, filed on Dec. 27, 2021, in the Japan Patent Office, the entire disclosure of which is hereby incorporated by reference herein.

### BACKGROUND

### Technical Field

Embodiments of the present disclosure relate to a liquid discharge apparatus, a liquid discharge method, and a storage medium storing program code.

### Related Art

In the related art, a liquid discharge apparatus is known to apply liquid discharged from a head to an application surface.

In order to apply liquid to an object having a three-dimensional curved surface (curved in two directions), for example, a liquid discharge apparatus has a configuration in which a reference length is compared with a curve length immediately below a plurality of nozzles of an inkjet head at a position of the three-dimensional curved surface on which liquid is to be discharged. In the liquid discharge apparatus, the amount of liquid droplets to be discharged from the plurality of nozzles is changed according to the ratio between the reference length and the curve length (for example, Japanese Unexamined Patent Application Publication No. 2016-123942).

### SUMMARY

Embodiments of the present disclosure described herein provide a novel liquid discharge apparatus including a head and circuitry. The head discharges liquid to apply the liquid to an application surface. The circuitry controls discharge of the liquid from the head based on a vertical height of an application position at which the liquid is applied on the application surface.

Embodiments of the present disclosure described herein provide a novel liquid discharge method to be executed by a liquid discharge apparatus. The method includes discharging and controlling. The discharging discharges liquid by a head to apply the liquid to an application surface. The controlling, by circuitry, controls discharge of the liquid from the head based on a vertical height of an application position at which the liquid is applied to the application surface.

Embodiments of the present disclosure described herein provide a novel non-transitory, computer-readable storage medium storing computer-readable program code that causes a liquid discharge apparatus, to perform discharging and controlling. The discharging discharges liquid by a head to apply the liquid to an application surface. The controlling, by circuitry, controls discharge of the liquid from the head based on a vertical height of an application position at which the liquid is applied to the application surface.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a side view illustrating an overall configuration of a liquid discharge apparatus according to embodiments of the present disclosure;

FIG. 2 is a front view illustrating the overall configuration of the liquid discharge apparatus according to embodiments of the present disclosure;

FIG. 3 is a diagram illustrating a hardware configuration of a controller according to embodiments of the present disclosure;

FIG. 4 is a diagram illustrating a configuration of a supply unit according to embodiments of the present disclosure;

FIG. 5 is a perspective view illustrating a configuration of a head according to embodiments of the present disclosure;

FIG. 6 is a cross-sectional view of the head cut by a plane S1 of FIG. 5;

FIG. 7 is a diagram illustrating a functional configuration of a controller according to a first embodiment of the present disclosure;

FIG. 8 is a flowchart of an operation of the liquid discharge apparatus according to the first embodiment of the present disclosure;

FIG. 9 is a diagram illustrating ink discharge according to a control sample;

FIG. 10 is a diagram illustrating ink applied to an application surface by the ink discharge illustrated in FIG. 9;

FIG. 11 is a diagram illustrating a state after ink dripping from the state illustrated in FIG. 10;

FIG. 12 is a diagram illustrating ink discharge according to a first embodiment;

FIG. 13 is a diagram illustrating an example of ink immediately after the ink is applied to an application surface by the ink discharge illustrated in FIG. 12;

FIG. 14 is a diagram illustrating a state after ink dripping from the state illustrated in FIG. 12;

FIG. 15 is a diagram illustrating a functional configuration of a controller according to a second embodiment of the present disclosure;

FIG. 16 is a diagram illustrating an example of the relation between the height and the amount of ink in a case where an inclination of the application surface is relatively small;

FIG. 17 is a diagram illustrating an example of the relation between the height and the amount of ink in a case where an inclination of the application surface is relatively large;

FIG. 18 is a diagram illustrating ink discharge according to the second embodiment;

FIG. 19 is a diagram illustrating an example of the ink applied to the application surface by the ink discharge illustrated in FIG. 18;

FIG. 20 is a side view of the state illustrated in FIG. 19;

FIG. 21 is a diagram illustrating a state after ink dripping from the state illustrated in FIG. 20;

FIG. 22 is a diagram illustrating an example of ink discharge in a case where the application surface is a flat and inclined surface;

FIG. 23 is a diagram illustrating a functional configuration of a controller according to a third embodiment of the present disclosure;

FIG. 24 is a diagram illustrating ink discharge according to the third embodiment;

FIG. 25 is a diagram illustrating an example of ink immediately after the ink is applied to the application surface by the ink discharge illustrated in FIG. 24; and

FIG. 26 is a diagram illustrating an example of application of a liquid discharge apparatus to a painting robot according to embodiments of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, a liquid discharge apparatus according to embodiments of the present disclosure are described in detail with reference to the drawings. However, the embodiments described below are some examples of the liquid discharge apparatus for embodying the technical idea of the present disclosure, and the embodiments of the present disclosure are not limited to the embodiments described below. Further, the size, material, and shape of components and the relative positions of the arranged components are given by way of example in the following description, and the scope of the present disclosure is not limited thereto unless particularly specified. Note that the size of these elements and the relative positions of these elements may be exaggerated for purposes of illustration in the drawings. In the description given below with reference to the drawings, like reference signs denote like elements, and overlapping description may be simplified or omitted as appropriate.

In the drawings illustrated below, directions may be indicated by X-axis, Y-axis, and Z-axis. An X-direction along the X-axis indicates a main scanning direction which is a moving direction of a carriage provided for the liquid discharge apparatus according to embodiments of the present disclosure. A Y-direction along the Y-axis indicates a sub-scanning direction intersecting the main scanning direction. A Z-direction along the Z-axis indicates a direction intersecting each of the X-direction and the Y-direction.

A direction in which an arrow points in the X-direction is denoted as +X-direction, and a direction opposite to the +X-direction is denoted as −X-direction. A direction in which an arrow points in the Y-direction is denoted as +Y-direction, and a direction opposite to the +Y-direction is denoted as −Y-direction. A direction in which an arrow points in the Z-direction is referred to as a +Z-direction, and a direction opposite to the +Z-direction is denoted as a −Z-direction. In the embodiments of the present disclosure described below, the Y-direction is along the vertical direction, and the Z-direction is along the horizontal direction substantially orthogonal to the vertical direction as an example. However, the above-described directions do not limit the orientation of the liquid discharge apparatus in use, and the liquid discharge apparatus may be oriented in any-direction.

### EMBODIMENTS

### Overall Configuration Example of Liquid Discharge Apparatus 1000

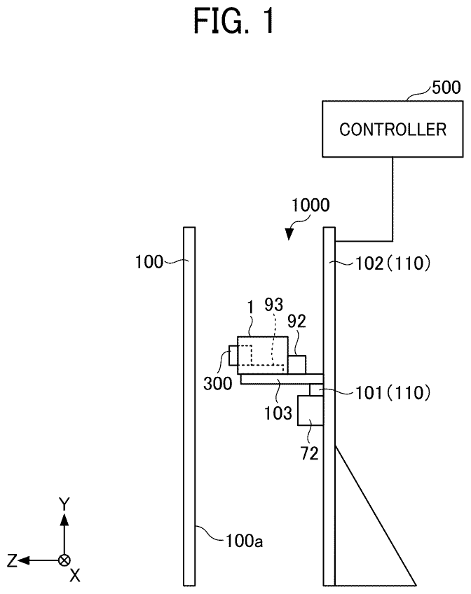

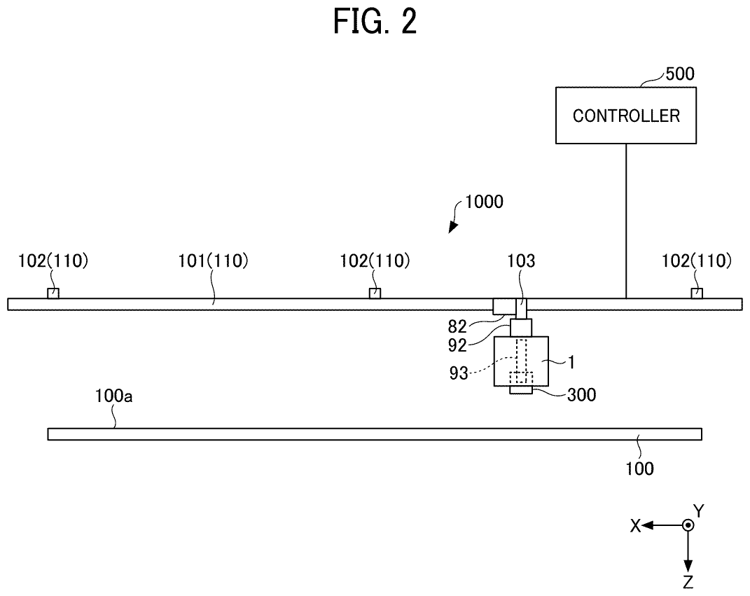

The configuration of a liquid discharge apparatus 1000 according to embodiments of the present disclosure is described with reference to FIGS. 1 and 2. FIGS. 1 and 2 are views illustrating an overall configuration of the liquid discharge apparatus 1000. FIG. 1 is a side view and FIG. 2 is a front view.

The liquid discharge apparatus 1000 applies ink, which is an example of liquid, to an application surface 100a of an object 100. The ink applied to the application surface 100a adheres to the application surface 100a after the ink dries. Either a continuous discharge type or a droplet discharge type can be applied to a discharge method of the liquid discharge apparatus 1000. Examples of the continuous discharge type include a valve method in which discharge is controlled by controlling the operation of a valve body, and a continuous method in which particles of ink continuously discharged from a nozzle are charged, bent by a deflection electrode, and sprayed onto a printing surface.

The examples of the application surface 100a include non-permeable surfaces such as bodies of cars, trucks, and airplanes. The term “non-permeable” refers to a characteristic that liquid applied to the application surface 100a of the object 100 does not permeate into the inside of the object 100. The liquid discharge apparatus 1000 can coat or paint a body of a car, a truck, or an aircraft by applying ink to the body. In FIG. 1, an example of a flat application surface 100a is illustrated.

The application surface 100a is not limited to a surface having non-permeability and may be a surface having permeability. The application surface 100a is not limited to a flat surface and may be a surface having a curvature in the X-direction or the Y-direction. The use of the liquid discharge apparatus 1000 is not limited to coating or painting and may be a use in which an image is formed (or printed) with ink on a recording medium such as a sheet or a film.

As illustrated in FIGS. 1 and 2, the liquid discharge apparatus 1000 includes a head 300, a mover 110, and a controller 500. In the liquid discharge apparatus 1000, the head 300 is disposed to face the application surface 100a of the object 100.

The head 300 is configured to discharge liquid such as ink to applies the ink to an application surface. The head 300 has a plurality of nozzles arranged at predetermined intervals in the Y-direction, and applies ink discharged from each of the nozzles to the application surface 100a. The head 300 is disposed on a carriage 1. However, the head 300 may not have a plurality of nozzles and may have one nozzle.

The mover 110 is a mechanism that relatively moves the head 300 and the application surface 100a along the surface of the application surface 100a. In the present embodiment, the mover 110 relatively moves the head 300 and the application surface 100a in each of the X-direction and the Y-direction along the surface of the application surface 100a. The mover 110 includes an X-axis rail 101 and a Y-axis rail 102.

A Z-axis rail 103 holds the carriage 1 so that the carriage 1 can move in the Z-direction. The X-axis rail 101 holds the Z-axis rail 103 such that the Z-axis rail 103 holding the carriage 1 is movable in the X-direction. The Y-axis rail 102 holds the X-axis rail 101 such that the X-axis rail 101 is movable in the Y-direction.

A Z-direction driver 92 moves the carriage 1 in the Z-direction along the Z-axis rail 103. A X-direction driver 72 moves the Z-axis rail 103 in the X-direction along the X-axis rail 101. A Y-direction driver 82 moves the X-axis rail 101 in the Y-direction along the Y-axis rail 102. Note that the movement of the carriage 1 and the head 300 in the Z-direction may not be parallel to the Z-direction and may be an oblique movement as long as the movement includes at least a component in the Z-direction.

The controller 500 is configured to control an operation of ink discharge to the application surface 100a by the liquid discharge apparatus 1000. The controller 500 is configured by a processor or an electric circuit mounted on an electric board. The controller 500 is electrically connected to at least each driver that drives the mover 110 and the head 300 in a wired or wireless manner. However, the electric board on which the controller 500 is mounted is arranged in any position, and the electric board may be arranged remotely with respect to the head 300.

The liquid discharge apparatus 1000 discharges ink from the head 300 toward the application surface 100a while moving the carriage 1 in each of the X-direction, the Y-direction, and the Z-direction to apply the ink to the application surface 100a.

More specifically, the liquid discharge apparatus 1000 discharges the ink from the head 300 and applies the ink to the application surface 100a while relatively moving the head 300 and the application surface 100a in the X-direction which is the main scanning direction.

After one relative movement in the X-direction is completed, the liquid discharge apparatus 1000 relatively moves the head 300 and the application surface 100a in the Y-direction which is the sub-scanning direction. After one relative movement in the Y-direction is completed, the liquid discharge apparatus 1000 discharges ink from the head 300 while relatively moving the head 300 and the application surface 100a in the X-direction again, to apply the ink to the application surface 100a. The liquid discharge apparatus 1000 repeats such relative movement in the X-direction and the Y-direction to apply ink to the application surface 100a.

In a case where the application surface 100a is a flat object along the X-direction and the Y-direction, the liquid discharge apparatus 1000 does not perform relative movement between the head 300 and the application surface 100a in the Z-direction during an ink application operation. In a case where the application surface 100a has a shape in which the height differs in the Z-direction, the liquid discharge apparatus 1000 performs relative movement between the head 300 and the application surface 100a in the Z-direction according to the shape of the application surface 100a during the ink application operation.

### Example of Hardware Configuration of Controller 500

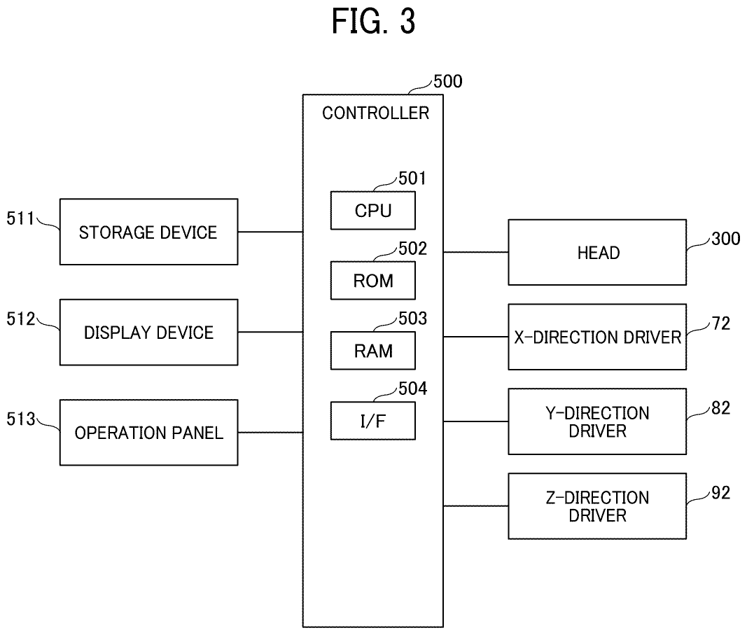

FIG. 3 is a block diagram illustrating an example of the hardware configuration of the controller 500 included in the liquid discharge apparatus 1000. The controller 500 includes a central processing unit (CPU) 501, a read only memory (ROM) 502, a random-access memory (RAM) 503, and an interface (I/F) 504. These units and components are electrically connected to each other through a system bus. The controller 500 is configured by, for example, a computer.

In addition, the controller 500 is electrically connected to the head 300, the X-direction driver 72, the Y-direction driver 82, the Z-direction driver 92, a storage device 511, a display device 512, and an operation panel 513.

The CPU 501 uses a RAM 503 as a work area and executes a program stored in the ROM 502 to control the overall operation of the controller 500.

The ROM 502 is a non-volatile memory that stores a program for executing control such as a recording operation to the CPU 501 and stores other fixed data.

The RAM 503 is a volatile memory that temporarily stores, for example, image data such as patterns and characters to be drawn on the application surface 100a and shape information of the body of the object 100.

The I/F 504 is an interface that enables communication between an external apparatus such as a host personal computer (PC) and the controller 500.

The storage device 511 is an external storage device such as a hard disk drive (HDD) or a solid state drive (SSD) that stores setting values set in advance. The information stored in the storage device 511 may be read and used by the CPU 501 when the CPU 501 executes a program.

Under the control of the controller 500, the display device 512 displays, for example, a setting screen for ink application conditions by the liquid discharge apparatus 1000.

The operation panel 513 is an operation input device such as a touch screen, a keyboard, or a mouse that receives an operation of the liquid discharge apparatus 1000. The operation panel 513 is used to input values (coordinates) for identifying an area where ink is discharged onto the application surface 100a, to input a movement speed of the carriage 1, to input values for identifying image information and three-dimensional coordinate information (body information) used for applying ink onto the application surface 100a, and to input a distance between the head 300 and the application surface 100a.

Note that the display device 512 and the operation panel 513 may be integrated into a single screen such as a touch screen.

The X-direction driver 72 drives the carriage 1 in the X-direction based on instructions from the controller 500. The Y-direction driver 82 drives the carriage 1 in the Y-direction based on instructions from the controller 500. The Z-direction driver 92 drives the carriage 1 in the Z-direction based on instructions from the controller 500.

The controller 500 controls the operations of the X-direction driver 72 and the Y-direction driver 82 to control the movement of the carriage 1, in which the head 300 is included, in the X-direction and the Y-direction. In addition, the controller 500 controls the operation of the Z-direction driver 92 to control the movement of the head 300 in the Z-direction with respect to the carriage 1. Further, the controller 500 controls discharge of ink from the head 300.

### Configuration Example of Supply Unit 200

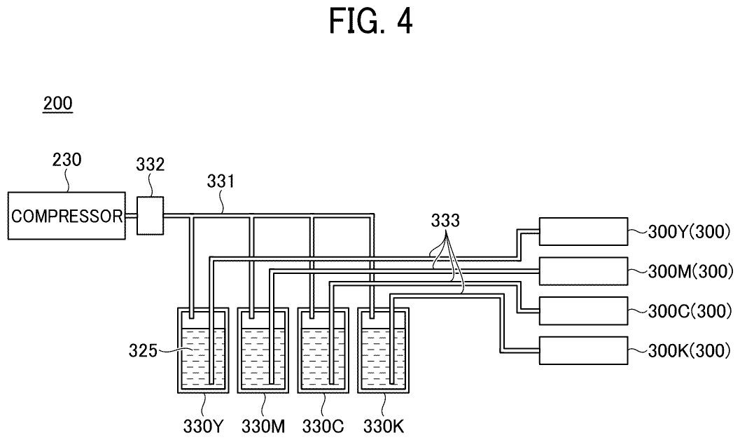

FIG. 4 is a diagram illustrating an example of the configuration of a supply unit 200 of the liquid discharge apparatus 1000. The supply unit 200 supplies ink to the head 300.

The head 300 includes a head 300Y that discharges yellow (Y) ink, a head 300M that discharges magenta (M) ink, a head 300C that discharges (C) ink, and a head 300K that discharges black (K) ink. In a case where the heads 300Y, 300M, 300C, and 300K are not distinguished from each other, the heads 300Y, 300M, 300C, and 300K are collectively referred to as the heads 300 in the description below.

The heads 300 may further include another head, such as a head 300Q that discharges overcoating ink and a head 300P that discharges primer ink or white ink. The supply unit 200 supplies ink of each color to the head 300 of each color.

The supply unit 200 includes ink tanks 330Y, 330M, 330C, and 330K (hereinafter referred to as ink tanks 330 unless distinguished) as sealed containers that stores inks 325 of magenta, cyan, yellow, and black to be discharged from the heads 300M, 300C, 300Y, and 300K, respectively. The ink tank 330 and an ink inlet (supply port) of the head 300 are connected to each other through a tube 333 so that ink 325 flows.

On the other hand, the ink tank 330 is connected to a compressor 230 through a pipe 331 including an air regulator 332, and the compressor 230 supplies pressurized air. Accordingly, the pressurized ink 325 of each color is supplied to the ink inlet of each head 300, and the liquid discharge apparatus 1000 discharges the ink 325 from each nozzle of the head 300.

### Configuration Example of Head 300

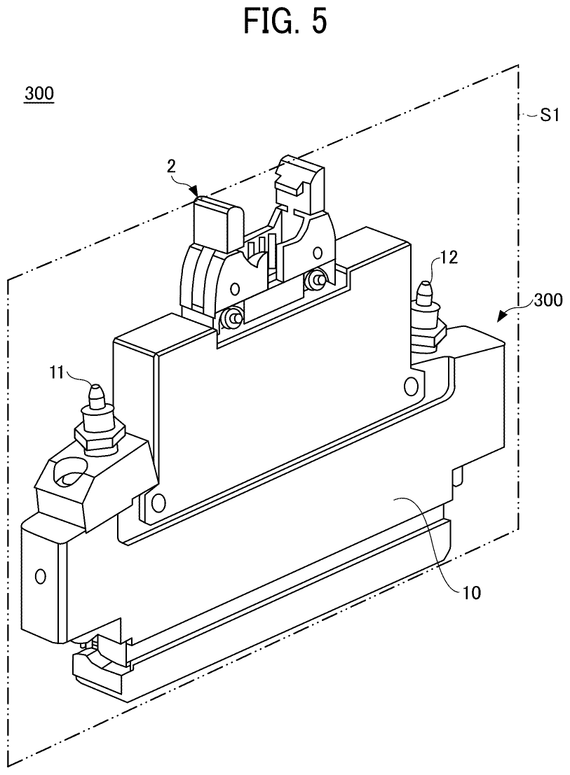

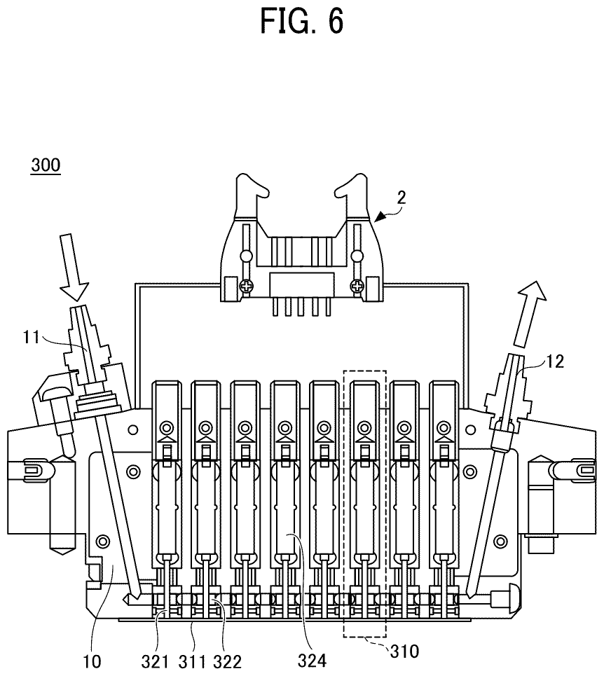

FIGS. 5 and 6 are schematic views illustrating an example of the configuration of the head 300. FIG. 5 is a perspective view of the head 300, and FIG. 6 is a cross-sectional view of the head 300 cut by a plane S1 of FIG. 5.

The head 300 includes a plurality of discharge modules 310 arranged in one or a plurality of rows in a housing 10.

The head 300 includes a supply port 11 and a collection port 12. The supply port 11 supplies pressurized ink from the outside to each discharge module 310, and the collection port 12 sends out non-discharged ink to the outside. The housing 10 is provided with a connector 2.

The discharge module 310 includes a nozzle plate 311, a channel 322, and piezoelectric elements 324. Nozzles 321 that discharge liquid are formed in the nozzle plate 311. The channel 322 communicates with the nozzles 321 to supply pressurized liquid to the nozzles 321. Each piezoelectric element 324 drives a valve body having a needle shape to open and close the nozzle 321.

The nozzle plate 311 is joined to the housing 10. The channel 322 is a channel common to the plurality of discharge modules 310 formed in the housing 10. The pressurized ink is supplied from the supply port 11, and non-discharged ink is sends out from the collection port 12. Note that the send-out of ink from the collection port 12 may be temporarily stopped to prevent a decrease in the discharging rate of ink from the nozzles 321 during a period in which ink is discharged to the application surface 100a.

### First Embodiment

### Example of Functional Configuration of Controller 500

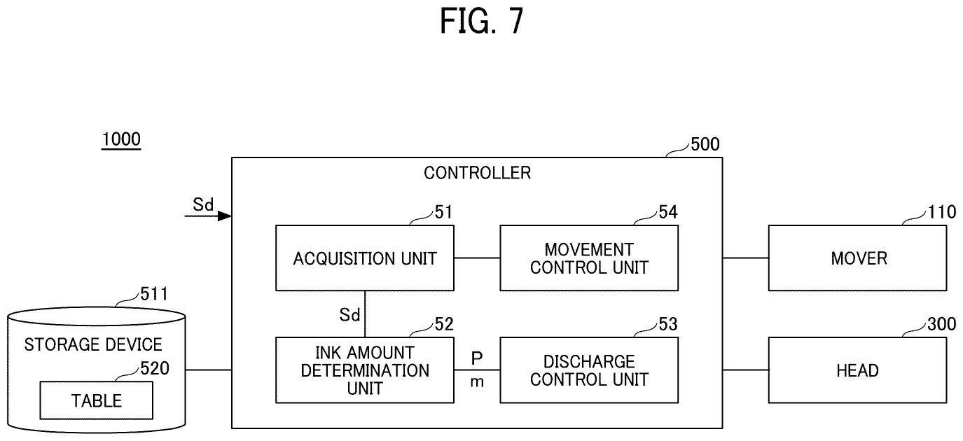

FIG. 7 is a diagram illustrating an example of the functional configuration of the controller 500. The controller 500 includes an acquisition unit 51, an ink amount determination unit 52, a discharge control unit 53, and a movement control unit 54.

The controller 500 controls the operation of the liquid discharge apparatus 1000 to apply ink to the application surface 100a. In particular, in the present embodiment, the controller 500 causes the ink amount determination unit 52 to determine the amount of the ink 325 to be discharged from the head 300 based on the shape information of the application surface 100a acquired from a host PC via the acquisition unit 51 and causes the discharge control unit 53 to discharge the ink 325 from the head 300. In addition, the controller 500 causes the movement control unit 54 to control the mover 110 based on the shape information of the application surface 100a to relatively move the head 300 and the application surface 100a.

The controller 500 implements the respective functions of the acquisition unit 51, the ink amount determination unit 52, the discharge control unit 53, and the movement control unit 54 by the CPU 501 deploying a program stored in the ROM 502 to the RAM 503 and executing the program.

Note that at least some of the functions of the controller 500 may be implemented by any other element such as the head 300 than the controller 500. Alternatively, at least some of the functions of the controller 500 may be implemented by the controller 500 and any other element than the controller 500 in a distributed manner.

The acquisition unit 51 inputs shape information Sd of the application surface 100a from an external device such as a host PC and acquires the shape information Sd. The shape information Sd is three-dimensional information representing the shape of the application surface 100a. The acquisition unit 51 may read the shape information Sd stored in advance in the storage device 511 to acquire the shape information Sd. Alternatively, the liquid discharge apparatus 1000 may include a detection unit to detect the shape of the application surface 100a, and the acquisition unit 51 may receive, from the detection unit, the shape information Sd of the application surface 100a detected by the detection unit to acquire the shape information Sd. The acquisition unit 51 outputs the acquired shape information Sd to the ink amount determination unit 52.

The ink amount determination unit 52 determines an ink amount m (amount of liquid) to be discharged from the head 300 based on the shape information Sd input from the acquisition unit 51. In the present embodiment, the ink amount determination unit 52 determines the ink amount m so that the ink amount m increase as a height h along the vertical direction (i.e., a vertical height h) of an application position P at which the ink 325 is applied on the application surface 100a increases.

For example, the ink amount determination unit 52 refers to a table 520 stored in the storage device 511 and determines the ink amount m based on the shape information Sd and the vertical height h of the application position P at which ink discharged from the head 300 is applied on the application surface 100a. The table 520 is a table indicating a relation between a predetermined height h and a predetermined ink amount m. The ink amount determination unit 52 outputs information of the ink amount m for each application position P to the discharge control unit 53.

The discharge control unit 53 causes the head 300 to discharge the ink amount m of the ink 325, determined by the ink amount determination unit 52. The discharge control unit 53 temporarily stores information of the ink amount m for each application position P input from the ink amount determination unit 52 in the RAM 503 and controls the ink amount m to be discharged from the head 300 according to the application position P that changes the position due to the relative movement of the head 300 by the mover 110.

In the case of the continuous discharge type, the discharge control unit 53 controls the time during which the head 300 discharges the ink 325, the discharge speed at which the head 300 discharges the ink 325, or the opening area of the nozzle of the head 300 so that the discharge control unit 53 can control the ink amount m discharged from the head 300. In the case of the droplet discharge type, the discharge control unit 53 controls the volume of ink droplets formed from the ink 325 or the pressure applied to ink in the head 300, thus allowing control of the ink amount m discharged from the head 300. The discharge control unit 53 can increase the volume of the ink droplet, for example, by combining a plurality of ink droplets.

The movement control unit 54 controls the relative movement by the mover 110. In the present embodiment, the movement control unit 54 controls the X-direction driver 72, the Y-direction driver 82, and the Z-direction driver 92 to control the relative movement by the mover 110. In the present embodiment, the movement control unit 54 controls the discharge of the ink 325 by the head 300 and the relative movement by the mover 110 so that the ink 325 discharged from the head 300 by a plurality of relative movements by the mover 110 is applied to the application surface 100a.

### Operation Example of Liquid Discharge Apparatus 1000

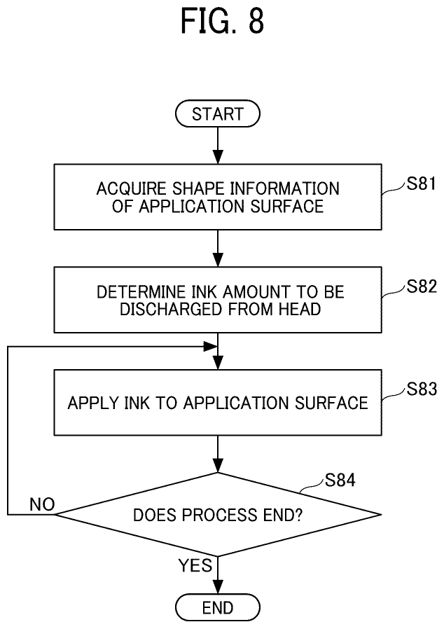

FIG. 8 is a flowchart of an operation of the liquid discharge apparatus 1000. FIG. 8 illustrates an operation of an ink application to the application surface 100a by the liquid discharge apparatus 1000. The liquid discharge apparatus 1000 starts the operation illustrated in FIG. 8, for example, when the liquid discharge apparatus 1000 receives an instruction of the ink application, input by a user through the operation panel 513.

First, in step S81, the acquisition unit 51 of the liquid discharge apparatus 1000 inputs the shape information Sd from the external apparatus such as the host PC and acquires the shape information Sd.

Subsequently, in step S82, the ink amount determination unit 52 of the liquid discharge apparatus 1000 determines the ink amount m to be discharged from the head 300 based on the shape information Sd input from the acquisition unit 51. The ink amount determination unit 52 outputs information of the determined ink amount m to the discharge control unit 53.

Subsequently, in step S83, the movement control unit 54 of the liquid discharge apparatus 1000 controls the relative movement between the head 300 and the application surface 100a by the mover 110. The discharge control unit 53 of the liquid discharge apparatus 1000 controls the discharge of the ink 325 from the head 300 to apply the ink 325 to the application surface 100a.

Subsequently, in step S84, the controller 500 of the liquid discharge apparatus 1000 determines whether the operation of the ink application to the application surface 100a is to be ended. The controller 500 can determine whether the operation of the ink application to the application surface 100a is to be ended based on, for example, data input by a user using the operation panel 513 or image data.

In step S84, when the controller 500 determines that the operation of the ink application to the application surface 100a is to be ended (YES in step S84), the liquid discharge apparatus 1000 ends the operation of the ink application. In step S84, when the controller 500 determines that the operation of the ink application to the application surface 100a is not to be ended (NO in step S84), the liquid discharge apparatus 1000 processes the operations of step S83 and step 84 again.

Due to the above-described processing, the liquid discharge apparatus 1000 can apply the ink 325 to the application surface 100a. In the present embodiment, the operation in which the ink amount determination unit 52 determines the ink amount m for each application position P in the overall application surface 100a in advance before the ink 325 is applied to the application surface 100a in step S83 has been described as an example. However, embodiments of the present disclosure are not limited to such a configuration. The ink amount determination unit 52 of the liquid discharge apparatus 1000 may determine the ink amount m each time the application position P on the application surface 100a changes the position due to the relative movement of the head 300 and output the ink amount m to the discharge control unit 53.

### Operation of Liquid Discharge Apparatus 1000

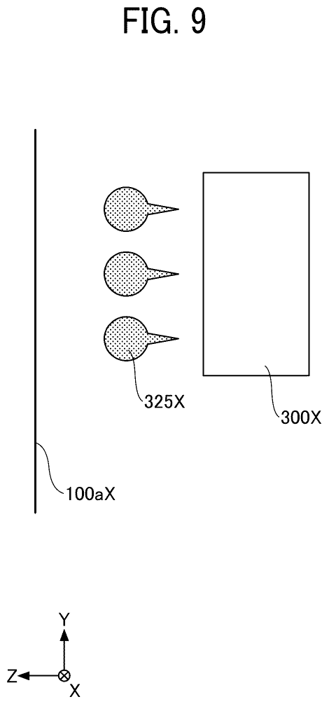

The operation of the liquid discharge apparatus 1000 according to an embodiment of the present disclosure is described with reference to FIGS. 9 to 14.

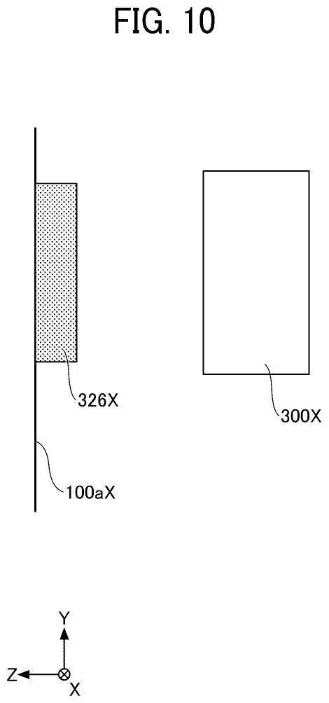

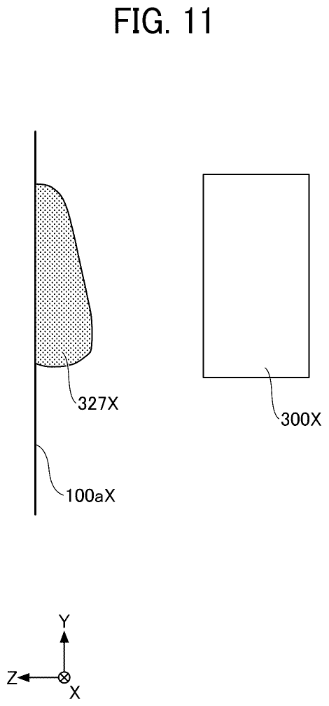

FIGS. 9 to 11 are diagrams illustrating ink application according to a control sample. FIG. 9 is a diagram illustrating ink discharge. FIG. 10 is a diagram illustrating ink immediately after the ink is applied to an application surface by the ink discharge illustrated in FIG. 9. FIG. 11 is a diagram illustrating a state after the ink has dripped as time elapses from the state illustrated in FIG. 10.

The ink dripping means that ink applied to an application surface drips from a high position to a low position on the application surface due to the action of gravity.

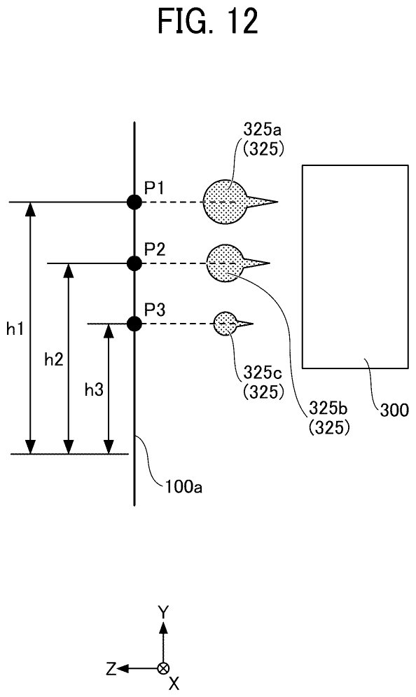

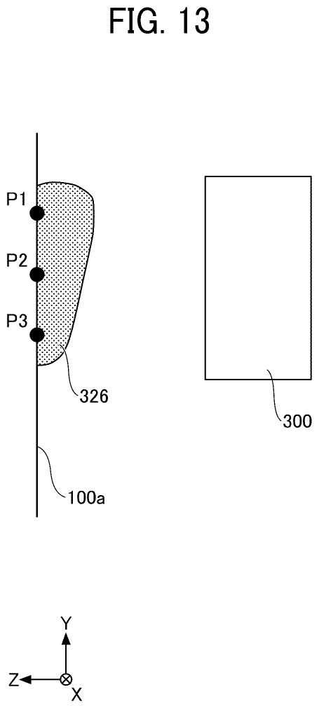

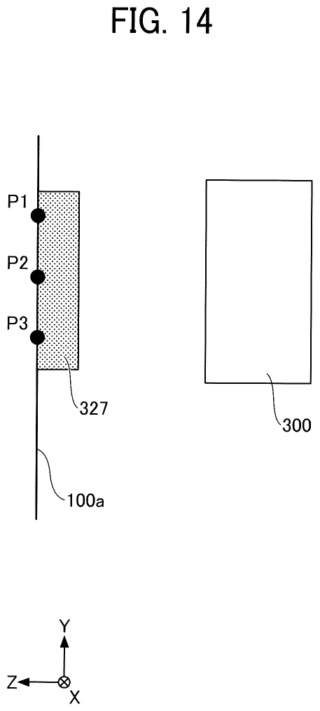

FIGS. 12 to 14 are diagrams illustrating ink application according to the present embodiment. FIG. 12 is a diagram illustrating an example of ink discharge. FIG. 13 is a diagram illustrating ink immediately after the ink is applied to an application surface by the ink discharge of FIG. 12. FIG. 14 is a diagram illustrating a state after the ink has dripped as time elapses from the state of FIG. 12.

As illustrated in FIG. 9, a head 300X according to the control sample discharges ink 325X to an application surface 100aX. In FIG. 9, the head 300X discharges three ink droplets formed with the ink 325X. In the control sample, the volumes of the three ink droplets are substantially equal.

As illustrated in FIG. 10, the ink 325X discharged from the head 300X forms an ink film 326X on the application surface 100aX immediately after the ink 325X is applied to the application surface 100aX. Since the ink 325X is not dried and has fluidity immediately after the ink 325X is applied to the application surface 100aX, the ink dripping occurs due to the action of gravity, and the ink 325X moves from a high position to a low position on the application surface 100aX. As drying progresses with a lapse of time, the amount of movement of the ink 325X from the high position to the low position on the application surface 100aX becomes smaller, and eventually stops and adheres to the application surface 100aX.

When the ink 325X in the ink film 326X drips downward (−Y-direction side) as illustrated in FIG. 11, an ink film 327X having a film thickness that increases toward the lower side is formed on the application surface 100aX.

As described above, in the control sample, the thickness of the ink film 327X formed on the application surface 100a is non-uniform.

In the present embodiment, as illustrated in FIG. 12, the liquid discharge apparatus 1000 increases the ink amount m of the ink 325 to be discharged from the head 300 as the height of the application position P in the vertical direction on the application surface 100a is higher. Application positions P1, P2, and P3 represent three application positions P having different heights in the vertical direction.

The application position P1 is a position at a height h1 from a reference height, the application position P2 is a position at a height h2 from the reference height, and the application position P3 is a position at a height h3 from the reference height. The reference height may be determined at any height, for example, the reference height may be the height of the ground on which the liquid discharge apparatus 1000 is installed. The height h1 is higher than each of the height h2 and height h3, and the height h2 is higher than the height h3. In other words, the height h1, the height h2, and the height h3 have a relation of “h1>h2>h3”.

The head 300 discharges and applies a large droplet 325a, which is an ink droplet formed with the ink 325, to the application position P1 of the application surface 100a. In addition, the head 300 discharges and applies a medium droplet 325b, which is an ink droplet formed with the ink 325 and has a smaller volume than the large droplet 325a, to the application position P2 of the application surface 100a. Further, the head 300 discharges and applies a small droplet 325c, which is an ink droplet formed with the ink 325 and has a smaller volume than the medium droplet 325b, to the application position P3 of the application surface 100a. The ink amount increases as the volume of ink droplet increases.

As illustrated in FIG. 13, the ink 325 discharged from the head 300 forms an ink film 326 on the application surface 100a immediately after the ink 325 is applied to the application surface 100a. The ink film 326 is the thickest at the application position P1 and becomes thinner in the order of the application position P2 and the application position P3 in accordance with the volumes of the ink droplets applied to the application positions P1, P2, and P3. In other words, immediately after the ink 325 is applied to the application surface 100a, the ink film 326 has a non-uniform thickness that is thicker toward the upper side (+Y-direction side).

When the ink dripping occurs due to the fluidity of the ink 325 from the state of the ink film 326, a part of the ink 325 applied to the application position P1 flows to the lower side. As a result, as illustrated in FIG. 14, the ink amount at each application position P along the vertical direction is substantially equalized, and then an ink film 327 having a substantially uniform film thickness is obtained.

### Effects of Liquid Discharge Apparatus 1000

As described above, the liquid discharge apparatus 1000 according to the present embodiment applies the ink 325 to the application surface 100a. The liquid discharge apparatus 1000 includes the head 300 that discharges and applies the ink 325 to the application surface 100a and the controller 500 that is configured to control discharge of the ink 325 by the head 300 based on the vertical height h of an application position P at which the ink 325 is applied on the application surface 100a.

For example, the controller 500 controls the ink amount m of the ink 325 discharged from the head 300 to increase the ink amount m as the height h of the application position P is higher.

Immediately after the ink 325 is applied to the application surface 100a, the ink film 326 formed on the application surface 100a with the ink 325 discharged from the head 300 has a larger thickness as the height h of the application position P is higher. However, the ink 325 having fluidity flows from an upper portion having a large film thickness to a lower portion having a small film thickness due to ink dripping by the action of gravity. As a result, the ink amount at each application position P along the vertical direction is substantially equalized, and thus the ink film 327 having a substantially uniform film thickness is obtained. Due to the above-described configuration, in the present embodiment, the liquid discharge apparatus 1000 which is excellent in the application qualities of the ink 325 to the application surface 100a can be provided.

In the present embodiment, an example in which the ink amount m is changed by changing the volume of the ink droplet has been described. However, embodiments of the present disclosure are not limited to this example. In the case of the continuous discharge type, the ink amount m may be changed by changing a time or a speed at which the ink 325 is discharged from the head 300 or a cross-sectional area of a nozzle disposed in the head 300. In the case of the droplet discharge type, the ink amount m may be changed by changing a discharge frequency of the ink 325 by the head 300 or a pressure applied to the ink 325 in the head 300 for discharge.

In the present embodiment, the liquid discharge apparatus 1000 includes the mover 110 that relatively moves the application surface 100a and the head 300 at least along the X-direction (predetermined direction). The controller 500 controls the discharge of the ink 325 by the head 300 and the relative movement by the mover 110 so that the ink 325 discharged from the head 300 is applied to the application surface 100a by a plurality of relative movements by the mover 110. Accordingly, the liquid discharge apparatus 1000 can move the head 300 in a wide range of the application surface 100a by the mover 110 and apply the ink 325. In addition, the liquid discharge apparatus 1000 can relatively move the application surface 100a and the head 300 also in the Y-direction by the mover 110 to apply the ink 325 to a wider range of the application surface 100a. Further, the liquid discharge apparatus 1000 can relatively move the application surface 100a and the head 300 also in the Z-direction to apply the ink 325 to a desired position on the application surface 100a even when the application surface 100a is a three-dimensional curved surface.

In addition, in the present embodiment, the liquid discharge apparatus 1000 includes the acquisition unit 51 that acquires the shape information Sd of the application surface 100a, and the controller 500 controls the discharge of the ink 325 by the head 300 based on the shape information Sd of the application surface 100a acquired by the acquisition unit 51. Accordingly, even when the application surface 100a is a surface having a three-dimensional shape such as a surface of a vehicle body, the liquid discharge apparatus 1000 can apply the ink amount m of the ink 325 corresponding to the height h.

### Second Embodiment

Next, a liquid discharge apparatus 1000a according to a second embodiment is described. Note that the same components as the components described in the first embodiment are denoted by the same reference numerals, and redundant description is omitted as appropriate. The same applies to embodiments and modifications described below.

In the present embodiment, a controller 500a included in the liquid discharge apparatus 1000a controls an ink amount m of ink 325 discharged from the head 300 based on a height h of an application position P along the vertical direction and an inclination θ of an application surface 100b with respect to the horizontal direction at the application position P.

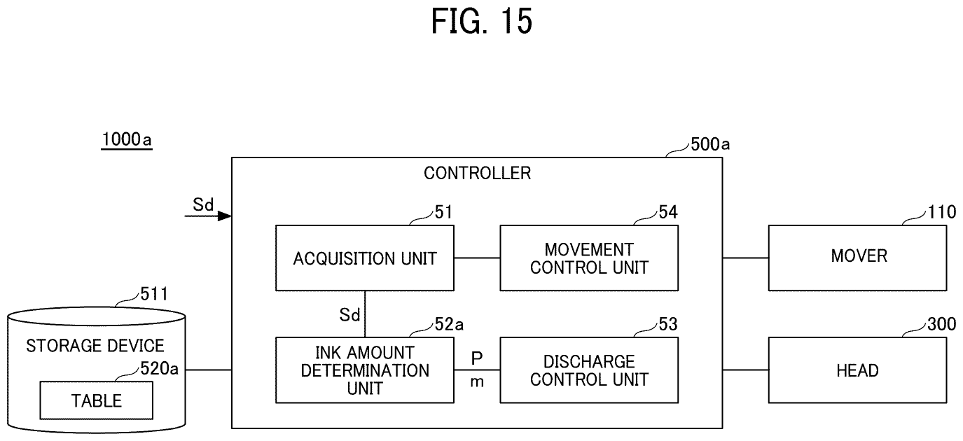

FIG. 15 is a diagram illustrating an example of the functional configuration of the controller 500a according to the second embodiment of the present disclosure. The controller 500a includes an ink amount determination unit 52a.

The ink amount determination unit 52a determines the ink amount m to be discharged from the head 300 based on the shape information Sd input from the acquisition unit 51. In the present embodiment, the ink amount determination unit 52a increases the ink amount m of the ink 325 discharged from the head 300 as the height h of the application position P is higher. In addition, the ink amount determination unit 52a determines the ink amount m so that the change in the ink amount corresponding to the predetermined height difference m is large as the inclination θ of the application surface 100b at the application position P is larger.

For example, the ink amount determination unit 52a calculates based on the shape information Sd to acquire the vertical height h of the application position P at which the ink 325 discharged from the head 300 is applied on the application surface 100b and the inclination θ of the application surface 100b with respect to the horizontal direction at the application position P. The ink amount determination unit 52a refers to a table 520a stored in the storage device 511 based on the acquired height h and inclination θ, and determines the ink amount m. The table 520a is a table indicating the relation between the predetermined height h, inclination θ, and the ink amount m. The ink amount determination unit 52a can output information of the ink amount m for each application position P to the discharge control unit 53.

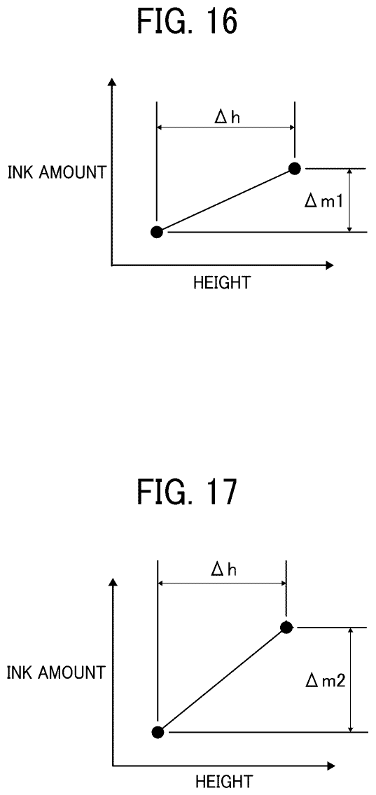

FIG. 16 is a diagram illustrating an example of a relation between the height h and the ink amount m in a case where the inclination θ of the application surface 100b is relatively small. FIG. 17 is a diagram illustrating an example of a relation between the height h and the ink amount m when the inclination θ of the application surface 100b is relatively large.

In FIGS. 16 and 17, the horizontal axis represents the height h, and the vertical axis represents the ink amount m. The height difference Δ h is a height difference per unit length and is an example of the predetermined height difference. The unit length of the height difference is, for example, one millimeter.

As illustrated in FIG. 16, in a case where the inclination θ of the application surface 100b is relatively small, a change in the ink amount m corresponding to the height difference Δh is Δm1. On the other hand, as illustrated in FIG. 17, in a case where the inclination θ of the application surface 100b is relatively large, a change in the ink amount m corresponding to the height difference Δh is Δm2. The change Δm2 is greater than the change Δm1.

As described above, the ink amount determination unit 52a can determine the ink amount m so that the change Δm in the ink amount m corresponding to the height difference Δh increases as the inclination θ of the application surface 100b at the application position P increases.

### Operation of Liquid Discharge Apparatus 1000a

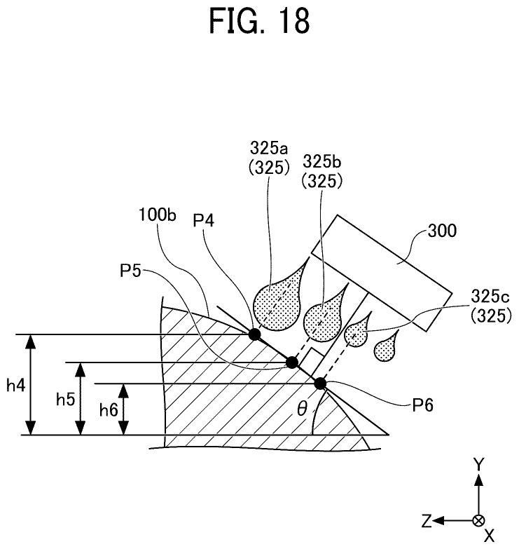

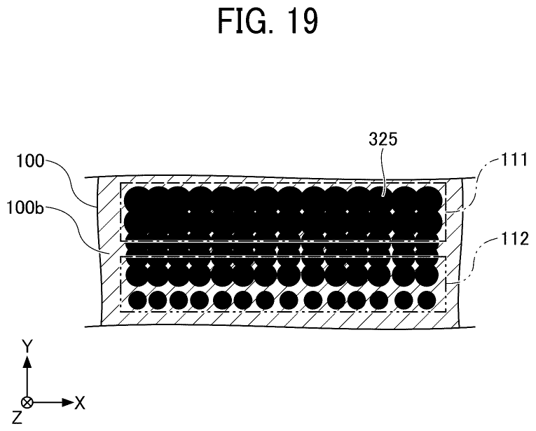

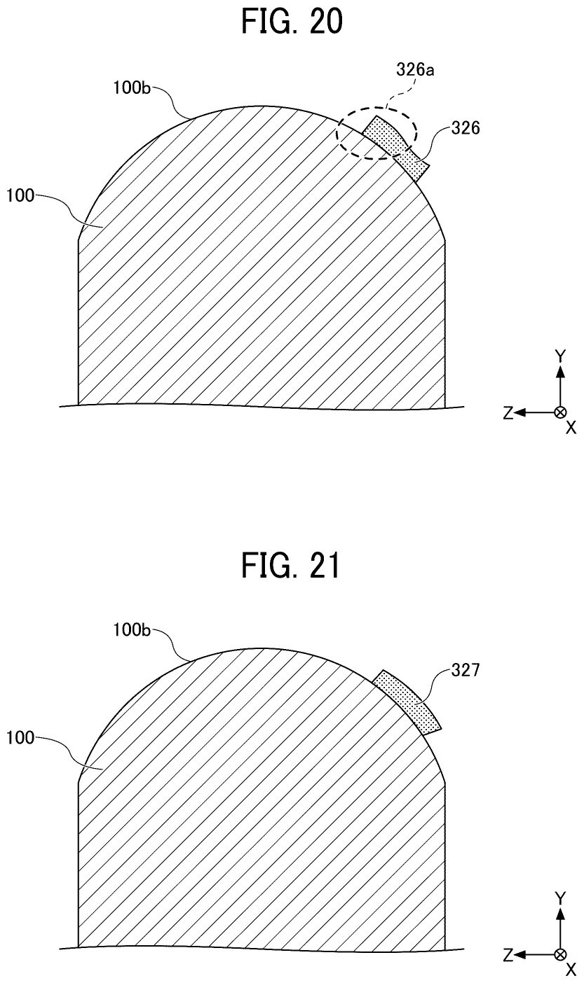

The operation of the liquid discharge apparatus 1000a is described with reference to FIGS. 18 to 21. FIG. 18 is a diagram illustrating an example of discharge of the ink 325 by the liquid discharge apparatus 1000a. FIG. 19 is a diagram illustrating an example of the ink 325 applied to the application surface 100b by the discharge illustrated in FIG. 18. FIG. 20 is a side view of the state illustrated in FIG. 19. FIG. 21 is a diagram illustrating an example of a state after the ink dripping as time elapses from the state illustrated in FIG. 20.

As illustrated in FIG. 18, application positions P4, P5, and P6 represent positions on the application surface 100b to which the ink 325 is applied. The application position P4 is a position at a height h4 from the reference height. The application position P5 is a position at a height h5 from the reference height. The application position P6 is a position at a height h6 from the reference height. The height h4 is higher than each of the height h5 and the height h6, and the height h5 is higher than the height h6. In other words, the relation among the heights h4, h5, and h6 is “h4>h5>h6”.

The inclination θ illustrated in FIG. 18 indicates an inclination of the application surface 100b at the application position P5 with respect to the horizontal direction (Z-direction). The application surface 100b is a surface having a curvature in at least one direction. In the present embodiment, the application surface 100b is a surface having a curvature in the Y-direction. The inclination with respect to the horizontal direction at the application position P4 is smaller than the inclination θ at the application position P5, and the inclination with respect to the horizontal direction at the application position P6 is larger than the inclination θ at the application position P5.

For example, the liquid discharge apparatus 1000a sets the ink amount m at the application position P4 to be larger than the ink amount m at the application position P6. In addition, the liquid discharge apparatus 1000a sets the change Δm in the ink amount m corresponding to the height difference Δh at the application position P6 to be larger than the change Δm in the ink amount m corresponding to the height difference Δh at the application position P4.

In the example illustrated in FIG. 18, the liquid discharge apparatus 1000a discharges a large droplet 325a, which is a droplet of the ink 325 and has a relatively large volume, from the head 300 to apply the large droplet 325a to the application position P4 on the application surface 100b. In addition, the liquid discharge apparatus 1000a discharges a medium droplet 325b having a smaller volume than the large droplet 325a from the head 300 to apply the medium droplet 325b to the application position P5 on the application surface 100b. Further, the liquid discharge apparatus 1000a discharges a small droplet 325c having a smaller volume than the medium droplet 325b from the head 300 to apply the small droplet 325c to the application position P6 on the application surface 100b. However, since the inclination at the application position P4 is smaller than the inclination at the application position P6, the difference between the ink amount m at the application position P4 and the ink amount m at the application position P6 is smaller than the difference of the ink amount m based on the difference between the height h4 and the height h6.

As illustrated in FIG. 19, the ink 325 is applied to form a first region 111 and a second region 112 on the application surface 100b. Large droplets 325a are applied to form the first region 111 on the application surface 100b, and small droplets 325c are applied to form the second region 112 on the application surface 100b. The first region 111 is located at a position higher than the second region 112 in the vertical direction.

Since the ink 325 has fluidity immediately after the ink 325 is applied to the application surface 100b, the ink 325 drips due to the action of gravity and moves from a high position to a low position on the application surface 100b. Then, as drying progresses with the lapse of time, the amount of movement of the ink 325 becomes smaller, and the ink 325 eventually stops and adheres to the application surface 100b.

Since the large droplets 325a are applied to the first region 111, the amount m of ink dripping is relatively large. Since the small droplets 325c are applied to the second region 112, the amount m of ink dripping is relatively small.

As illustrated in FIG. 20, the ink 325 discharged from the head 300 forms an ink film 326 on the application surface 100a immediately after the ink 325 is applied to the application surface 100b. In accordance with the volumes of the ink droplets applied to the application positions P4, P5, and P6, the ink film 326 has a non-uniform thickness in which the thickness increases toward the upper side. For example, the ink film 326 has a larger thickness in an upper region 326a of the ink film 326.

When ink dripping occurs due to the fluidity of the ink 325 from the state of the ink film 326 as illustrated in FIG. 20, a part of the ink 325 flows to the lower side. As a result, as illustrated in FIG. 21, the ink amount at each application position P on the application surface 100b is substantially equalized, and then an ink film 327 having a substantially uniform film thickness is obtained.

### Effects of Liquid Discharge Apparatus 1000a

As described above, the controller 500a included in the liquid discharge apparatus 1000a according to the present embodiment controls the ink amount m of the ink 325 to be discharged from the head 300 based on the height h of the application position P along the vertical direction and the inclination θ of the application surface 100b with respect to the horizontal direction at the application position P.

For example, the controller 500a increases the ink amount m applied to the application surface 100b as the height h of the application position P in the vertical direction is higher. In addition, the controller 500a controls so that the change Δm of the ink amount m corresponding to the height difference Δh (predetermined height difference) increases as the inclination θ of the application surface 100b at the application position P increases.

Immediately after the ink 325 is applied to the application surface 100b, the ink film 326 formed on the application surface 100b by the ink 325 discharged from the head 300 has a larger thickness as the height h of the application position P is higher. However, the ink 325 having fluidity flows from an upper portion having a large film thickness to a lower portion having a small film thickness due to ink dripping by the action of gravity. As a result, the amount of ink at each application position P along the vertical direction is substantially equalized, and thus the ink film 327 having a substantially uniform film thickness is obtained. Due to the above-described configuration, in the present embodiment, the liquid discharge apparatus 1000a excellent in the application qualities of the ink 325 to the application surface 100b can be provided.

In the present embodiment, the application surface 100b is a surface having a curvature in at least one direction. The liquid discharge apparatus 1000a can also obtain the application qualities of the ink 325 to the application surface 100b in the case of the application surface 100b as described above.

Note that the effects other than described above in the liquid discharge apparatus 1000a are the same as the effects of the liquid discharge apparatus 1000 according to the first embodiment.

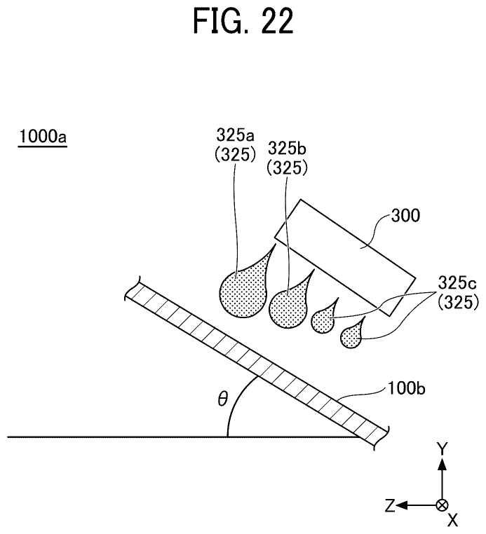

In the present embodiment, a curved surface having a curvature in at least one direction have been exemplified as the application surface 100b. In some embodiments, however, the application surface 100b may be a flat and inclined surface. FIG. 22 is a diagram illustrating an example of discharge of the ink 325 in a case where the application surface 100b is a flat and inclined surface.

As illustrated in FIG. 22, the application surface 100b is a flat and inclined surface inclined by an inclination θ with respect to the Z-direction (horizontally). The liquid discharge apparatus 1000a causes the controller 500a to control the ink amount m of the ink 325 to be discharged from the head 300 based on the height h of the application position P along the vertical direction and the inclination θ of the application surface 100b with respect to the horizontal direction at the application position P. Accordingly, the same operation effect of the liquid discharge apparatus 1000a described above can be obtained.

### Third Embodiment

Next, a liquid discharge apparatus 1000b according to a third embodiment is described.

In the present embodiment, a controller 500b included in the liquid discharge apparatus 1000b controls an interval d between adjacent liquids such as adjacent inks 325 discharged from the head 300 and applied to the application surface 100b.

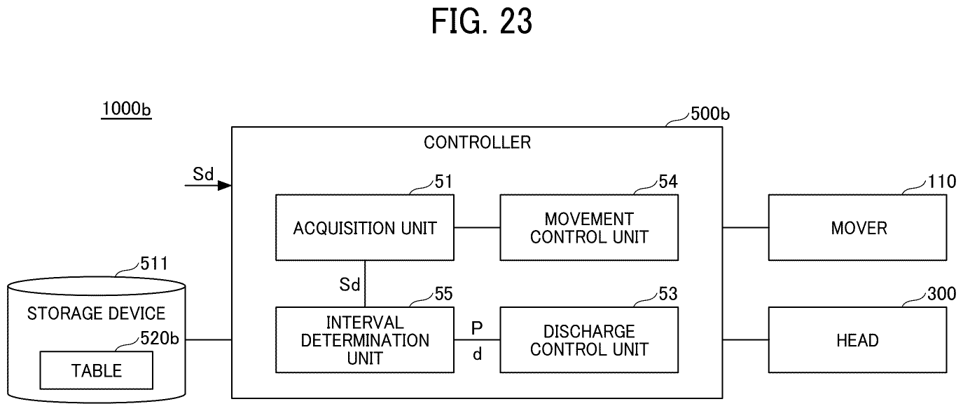

FIG. 23 is a diagram illustrating an example of the functional configuration of the controller 500b. The controller 500b includes an interval determination unit 55.

The interval determination unit 55 determines the interval d between the adjacent inks 325 which are discharged from the head 300 and are applied to the application surface 100b, based on the shape information Sd input from the acquisition unit 51. In the present embodiment, the interval determination unit 55 sets the interval d between the adjacent inks 325 applied to the application surface 100b to be narrower as the height h of the application position P along the vertical direction is higher. In addition, as the inclination θ of the application surface 100b at the application position P increases, the interval determination unit 55 determines the interval d so that the change Δd corresponding to the predetermined height difference of the interval d between the adjacent inks 325 applied to the application surface 100b increases.

For example, the interval determination unit 55 calculates, based on the shape information Sd, the vertical height h of the application position P at which the ink 325 discharged from the head 300 is applied on the application surface 100b and the inclination θ of the application surface 100b with respect to the horizontal direction at the application position P, to acquire the height h and the inclination θ. The interval determination unit 55 refers to a table 520b stored in the storage device 511 based on the acquired height h and inclination θ and determines the interval d. The table 520b is a table indicating the relation between the predetermined height h, the inclination θ, and the interval d. The interval determination unit 55 can output information of the interval d for each application position P to the discharge control unit 53.

### Operation of Liquid Discharge Apparatus 1000b

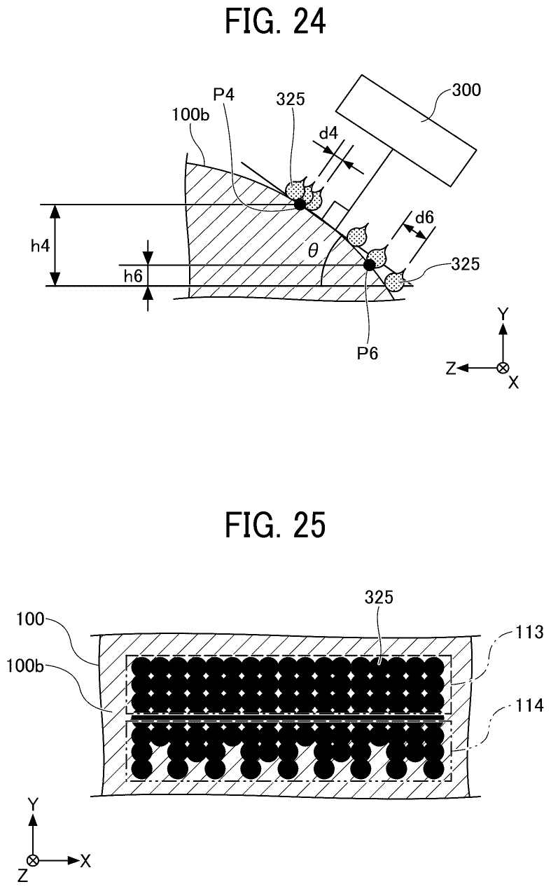

The operation of the liquid discharge apparatus 1000b is described with reference to FIGS. 24 and 25. FIG. 24 is a diagram illustrating an example of the ink discharge by the liquid discharge apparatus 1000b. FIG. 25 is a diagram illustrating an example of the ink 325 applied to the application surface 100b by the ink discharge illustrated in FIG. 24.

The height h4 of the application position P4 is higher than the height h6 of the application position P6. The inclination θ of the application surface 100b at the application position P6 is larger than the inclination θ of the application surface 100b at the application position P4.

The liquid discharge apparatus 1000b sets an interval d4 between the adjacent inks 325 applied to the application surface 100b at the application position P4 to be narrower than an interval d6 between the adjacent inks 325 applied to the application surface 100b at the application position P6. The liquid discharge apparatus 1000b controls so that the change Δd corresponding to the height difference Δh of the interval d between the adjacent inks 325 applied to the application surface 100b is larger as the inclination θ of the application surface 100b at the application position P is larger.

In the example illustrated in FIG. 24, the interval d between the adjacent inks 325 in the application position P4 is indicated by the interval d4. The interval d between the adjacent inks 325 in the application position P6 is indicate by the interval d6. The interval d4 is narrower than the interval d6. Since the inclination θ at the application position P4 is smaller than the inclination θ at the application position P6, the difference between the interval d4 at the application position P4 and the interval d6 at the application position P6 is smaller than the difference of the interval d based on the difference between the height h4 and the height h6.

As illustrated in FIG. 25, the ink 325 is applied to form a third region 113 and a fourth region 114 on the application surface 100b. The third region 113 is located at a position higher than the fourth region 114 in the vertical direction. Comparing the interval d between the adjacent inks 325, the interval d4 in the third region 113 is narrower than the interval d6 in the fourth region 114. Note that the volumes of ink droplets applied to the third region 113 and the fourth region 114 are substantially equal.

Since the ink 325 has fluidity after the ink 325 is applied to the application surface 100b, the ink 325 drips due to the action of gravity and moves from a high position to a low position on the application surface 100b. Then, as drying progresses with the lapse of time, the amount of movement of the ink 325 becomes smaller, and the ink 325 eventually stops and adheres to the application surface 100b.

Since the ink amount m increases as the interval d between the inks 325 on the application surface 100b decreases, the ink amount m in the third region 113 becomes larger than the ink amount m in the fourth region 114.

When ink dripping occurs due to the fluidity of the ink 325 from the state illustrated in FIG. 25, a part of the ink 325 applied to each of the third region 113 and the fourth region 114 flows to the lower side. As a result, the ink amount at each application position P on the application surface 100b is substantially equalized, and thus an ink film having a substantially uniform film thickness is obtained.

### Effects of Liquid Discharge Apparatus 1000b

As described above, the controller 500b included in the liquid discharge apparatus 1000b according to the present embodiment controls the interval d between the adjacent inks 325 which are discharged from the head 300 and applied to the application surface 100b.

For example, the controller 500b sets the interval d between the adjacent inks 325 applied to the application surface 100b to be narrower as the height h of the application position P along the vertical direction is higher. In addition, the controller 500b controls so that the change Δd corresponding to the height difference Δh of the interval d between the adjacent inks 325 applied to the application surface 100b increases as the inclination θ of the application surface 100b at the application position P is larger.

Immediately after the ink 325 is applied to the application surface 100b, the ink film formed on the application surface 100b with the ink 325 discharged from the head 300 has a larger thickness as the height h of the application position P is higher. However, the ink 325 having fluidity flows from an upper portion having a large film thickness to a lower portion having a small film thickness due to ink dripping by the action of gravity. As a result, the ink amount at each application position P along the vertical direction is substantially equalized, and thus an ink film having a substantially uniform film thickness is obtained. Due to the above-described configuration, in the present embodiment, the liquid discharge apparatus 1000b which is excellent in the application qualities of the ink 325 to the application surface 100b can be provided.

Note that the liquid discharge apparatus 1000b may control the interval d based on only the height h of the application position P. In addition, the liquid discharge apparatus 1000b may control the ink amount m and the interval d based on only the height h of the application position P. Further, the liquid discharge apparatus 1000b may control the ink amount m and the interval d based on the height h of the application position P and the inclination θ of the application surface 100b at the application position P. Note that the effects other than described above in the liquid discharge apparatus 1000b are the same as the effects of the liquid discharge apparatus 1000 according to the first embodiment.

### OTHER EMBODIMENTS

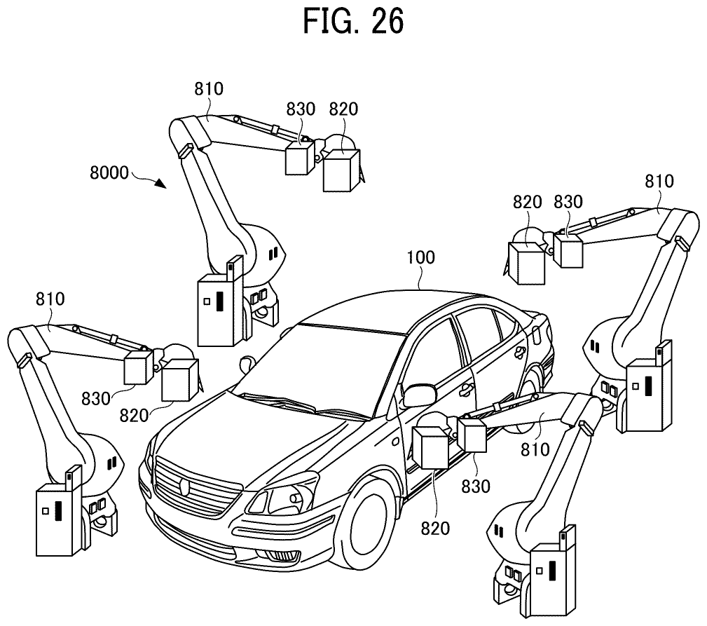

The liquid discharge apparatus 1000, the liquid discharge apparatus 1000a, or the liquid discharge apparatus 1000b can be applied to various uses. FIG. 26 is a diagram illustrating an example of application of the liquid discharge apparatus 1000 to a painting robot 8000. The painting robot 8000 paints a vehicle body (body) of an automobile.

The painting robot 8000 includes a robot arm 810 that can freely move like human arms by a plurality of joints and includes a head 820 that discharges ink from a leading end of the robot arm 810. The robot arm 810 includes a three-dimensional (3D) sensor 830 disposed close to the head 820.

As the painting robot 8000, an articulated robot can be used that has an appropriate number of axes such as five axes, six axes, or seven axes. The painting robot 8000 detects a position of the head 820 with respect an object 100 (vehicle body in the present embodiment) by the 3D sensor 830 and moves the robot arm 810 based on the result of the detection to paint the object 100. In this case, the head 300 according to the embodiments of the present disclosure can be used as the head 820.

Although the embodiments have been described above, embodiments of the present disclosure are not limited to the above embodiments. In other words, various modifications and improvements can be made within the scope of the present disclosure.

In the embodiments of the present disclosure, for example, a liquid to be discharged from the head 300 may include a solution, a suspension, or an emulsion that contains, for example, a solvent, such as water or an organic solvent, a colorant, such as dye or pigment, a functional material, such as a polymerizable compound, a resin, or a surfactant, a biocompatible material, such as deoxyribonucleic acid (DNA), amino acid, protein, or calcium, or an edible material, such as a natural colorant. These liquids can be used for, e.g., inkjet ink, coating paint, surface treatment solution, a liquid for forming components of electronic element or light-emitting element or a resist pattern of electronic circuit, or a material solution for three-dimensional fabrication.

The object 100 having the application surface 100a is a material to which liquid is attached and firmly adheres or an object to which liquid is attached and penetrates. Specific examples of the material include, but are not limited to, a recording medium such as a vehicle body, building material, a sheet, recording sheet, a recording sheet of paper, a film, or cloth, an electronic component such as an electronic substrate or a piezoelectric element, and a medium such as layered powder, an organ model, or a testing cell. The material includes any material to which liquid is adhered, unless particularly limited.

The embodiments of the present disclosure also include a liquid discharge method. For example, the liquid discharge method is a method of discharging liquid using a liquid discharge apparatus that applies the liquid to an application surface. The liquid discharge apparatus applies the liquid discharged from a nozzle to the application surface using a head and causes a controller to control discharge of the liquid by the head based on a height along a vertical direction of an application position where the liquid is applied on the application surface. Such a liquid discharge method as described above can achieve operational effects equivalent to those of the above-described liquid discharge apparatus.

The embodiments of the present disclosure also include a storage medium storing computer-readable program instructions and a computer-readable program product. For example, a program is a program that causes a liquid discharge apparatus to execute a process that the liquid discharge apparatus applies a liquid discharged to an application surface by a head and controls discharge of the liquid by the head based on a height along a vertical direction of an application position at which the liquid is applied on the application surface by a controller. The storage medium or a computer-readable program product including such program instructions can provide effects equivalent to those of the above-described liquid discharge apparatus.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

What is claimed is:

1. A liquid discharge apparatus comprising:
a head configured to discharge liquid to apply the liquid to an application surface; and
circuitry configured to control discharge of the liquid from the head based on a vertical height of an application position at which the liquid is applied on the application surface and based on an inclination of the application surface with respect to a horizontal direction at the application position.

2. The liquid discharge apparatus according to claim 1,
wherein the application surface is a surface having a curvature in at least one direction.

3. The liquid discharge apparatus according to claim 1,
wherein the circuitry is configured to control an amount of the liquid discharged from the head.

4. The liquid discharge apparatus according to claim 3, wherein:
the head is configured to discharge a droplet of the liquid; and
the circuitry is configured to change volume of the droplet of the liquid to control the amount of the liquid discharged from the head.

5. The liquid discharge apparatus according to claim 3,
wherein the circuitry is configured to increase the amount of the liquid to be discharged from the head as the vertical height of the application position on the application surface is higher.

6. The liquid discharge apparatus according to claim 3,
wherein the circuitry is configured to control the amount of the liquid in a manner such that a change in the amount of the liquid corresponding to a predetermined height difference is larger as an inclination of the application surface at the application position is larger.

7. The liquid discharge apparatus according to claim 1,
wherein the circuitry is configured to control an interval between adjacent liquids discharged from the head to be applied to the application surface.

8. The liquid discharge apparatus according to claim 7,
wherein the circuitry is configured to set the interval to be narrower as the vertical height of the application position is higher.

9. The liquid discharge apparatus according to claim 8,
wherein the circuitry is configured to control the interval in a manner such that a change corresponding to a predetermined height difference in the interval increases as an inclination of the application surface at the application position is larger.

10. The liquid discharge apparatus according to claim 1, further comprising
a mover configured to relatively move the application surface and the head at least along a predetermined direction, and
wherein the circuitry is configured to control the discharge of the liquid by the head and relative movements by the mover in a manner such that the liquid discharged from the head is applied to the application surface by a plurality of relative movements by the mover.

11. The liquid discharge apparatus according to claim 1, wherein the circuitry configured to:
acquire shape information of the application surface; and
control the discharge of the liquid by the head based on the shape information acquired.

12. A liquid discharge method to be executed by a liquid discharge apparatus, the method comprising:
discharging liquid by a head to apply the liquid to an application surface; and controlling, by circuitry, discharge of the liquid from the head based on a vertical height of an application position at which the liquid is applied to the application surface and based on an inclination of the application surface with respect to a horizontal direction at the application position.

13. A non-transitory, computer-readable storage medium storing computer-readable program code that causes a liquid discharge apparatus, to perform:
discharging liquid by a head to apply the liquid to an application surface; and
controlling, by circuitry, discharge of the liquid from the head based on a vertical height of an application position at which the liquid is applied to the application surface and based on an inclination of the application surface with respect to a horizontal direction at the application position.

14. The liquid discharge apparatus according to claim 3, wherein:
the head is configured to continuously discharge the liquid; and
the circuitry is configured to change a time or a speed of discharging of the liquid to control the amount of the liquid discharged from the head.
